(19) United States
(12) Patent Application Publication
(10) Pub. No.: US 2026/0275763 A1
(43) Pub. Date: Sep. 17, 2026

(54) A DEVICE FOR HOLDING A KEY OF A VEHICLE

(71) Applicant: SCHEDONI S.R.L., Modena (IT)

(72) Inventors: Simone Schedoni, Modena (IT); Alessio Boninsegni, Modena (IT)

(73) Assignee: SCHEDONI S.R.L., Modena (IT)

(21) Appl. No.: 19/162,397

(22) PCT Filed: Mar. 8, 2024
(86) PCT No.: PCT/IB2024/052257

§ 371 Date: Sep. 4, 2025

(30) Foreign Application Priority Data
Mar. 10, 2023 (IT) 102023000004476

(51) Int. Cl. E05B 19/00; G07C 9/00

(52) U.S. Cl. CPC E05B 19/0082; G07C 9/00944

(57) ABSTRACT

Device for holding a key (3) of a vehicle, such as a car, motorcycle, or the like, which key (3) comprises a body having a peripheral edge (31).

The said device comprises a frame element (1), which frame element (1) is configured to surround and overlap the peripheral edge (31) of said key (3), in an overlapped condition, the frame element (1) being engaged with the body of said key (3).

There is also an eyelet element (2), which eyelet element has a pin (21) for attaching to the frame element (1).

The present invention relates to a device for holding a key of a vehicle, such as a car, motorcycle, or the like, which key comprises a body having a peripheral edge.

The present invention relates, preferably, but not exclusively to the keys of vehicles that use the “keyless” system, i.e. keys that interact through wireless technologies with the electronic control unit of the vehicle to allow the opening or starting of the vehicle.

Keys that use “keyless” technology generally consist of a body made of plastic material, in a parallelepiped shape, in which both the logo of the vehicle brand and any control buttons can be shown on the wider faces.

Consequently, the body made of plastic material also has a peripheral edge, of a certain width, depending on the thickness of the key.

The advantage of these keys is that the user does not necessarily have to insert the key inside a corresponding lock, but it is sufficient that the key is located near the vehicle.

Despite the advantages just discussed, such keys present the problem of portability, i.e. users are forced to carry the key separately from other keys, as, precisely because of their conformation, they cannot be coupled to the keychains known in the state of the art.

This problem is particularly apparent in the luxury car market, where users can have the pleasure of associating an aesthetically pleasing keychain with the key of an important car, in order to give the key system and keychain a relevant meaning, both from an aesthetic and from a cost point of view.

From what has just been described, it is evident that this problem is not exclusively related to keys using “keyless” technology, but to any type of key that has a body that cannot be attached to a keychain.

There is therefore a need not met by the devices known to the state of the art to be able to easily couple any type of key to a keychain, in order to improve its portability and aesthetic appearance.

The present invention achieves the above purposes by realising a device as described above, wherein the device comprises a frame element configured to surround and overlap the peripheral edge of the key.

In the overlapped condition, the frame element is engaged with the body of the key.

There is also an eyelet element, which has a pin for attaching to the frame element.

The device that is the object of the present invention, therefore, allows an eyelet element to be associated easily with a key, an eyelet element that can be used for the coupling of the key to a keychain.

As will be evident from the illustration of some executive examples, the device for holding a key that is the object of the present invention is also particularly customizable, so as to diversify the device itself according to the associated key, for example by colour, shapes, logos, designs or the like.

It follows that this will not only be advantageous for the end user, but also for the dealer, since it enables differentiation of keys that are the same, but are for different vehicles.

Starting from this general concept, it is possible to envisage refinements of the frame element in order to facilitate the coupling between the frame element and the peripheral edge of the key.

In fact, the frame element can have any shape and size, which allows the frame element to be attached to the key, so as to associate the eyelet element with the latter.

Therefore, it is not necessary for the frame element to have the same shapes and dimensions as the peripheral edge of the key, as it can overlap the latter even partially, through any attachment.

According to a preferred embodiment, the frame element has the dimensions of the peripheral edge of the key, so as to ensure the attachment of the frame element to the key by form fit.

According to this configuration, the frame element can be made of any material known to the state of the art.

As mentioned above, one of the purposes of the device that is the object of the present invention is also the improvement of the aesthetic characteristics of the key held within the device itself.

For this reason, it is possible to provide that the frame element is coated with an aesthetically pleasing-looking material, such as leather, hide or similar materials.

According to a possible embodiment, the frame element is made of elastically deformable material, i.e. having a certain level of elastic deformation. For example, the frame element can be made of rubbery materials, as well as plastic materials that allow deformation of the frame element itself in order to adapt it to the dimensions of the peripheral edge of the key.

In this case, therefore, the coupling of the frame element to the key is guaranteed by the elastic force of the frame element, which is deformed, positioned at the peripheral edge of the key and held on the peripheral edge by the force exerted by the material constituting the frame element to return to the original dimensions.

According to this configuration, the frame element therefore tends to encircle the peripheral edge of the key, in the case where the frame element has dimensions slightly smaller than the body of the key.

According to a possible embodiment, the frame element is formed by an elongated element.

The elongated element obviously has two ends that can be attached together, according to different methods, which will be described later, so as to delimit an internal zone, which has the shape of the body of the key.

To facilitate the production of the device that is the object of the present invention and to obtain a particularly simple device to use, advantageously, the frame element is an integrally formed element, that is, it forms a ring that is closed, without interruption.

As an alternative to such a configuration, the frame element is not made as a closed ring, but the ends of the elongated element can be attached to each other.

In this way, the frame element changes from an open condition, with the ends separated from each other, to a closed condition, with the ends joined to each other.

It is evident that this configuration facilitates the positioning of the frame element around the peripheral edge, being able to also use particularly rigid materials, such as wood or metals, for the realization of the frame element.

In combination with this variant, it is specified that the ends of the elongated element can be attached to each other, always in a movable manner, in any of the ways known to the state of the art.

Advantageously, in order to limit the number of components of the device that is the object of the present invention, the eyelet element can be used to attach the ends of the elongated element.

Each end can therefore have a corresponding through hole, which through holes are aligned with each other in the closed condition of the frame element, so as to identify a housing seat for the pin of the eyelet element.

The eyelet element thus has a double functionality, that is, it allows both the key to be coupled to a keychain, and the ends of the elongated element to be locked in place.

According to a further embodiment variant, the frame element consists of a ribbon-shaped element configured to overlap with its surface the peripheral edge of the body of the key.

As will be evident from the illustration of some executive examples, the embodiment as a ribbon-shaped element provides a stable attachment of the frame element to the body of the key, avoiding unintentional slippages.

In order to further improve the attachment of the frame element to the key body, it is possible to provide that the ribbon-shaped element has a relief rib arranged along the longitudinal axis of the ribbon-shaped element, which rib extends in the direction of the peripheral edge of the key body, in the attached condition of the frame element to the key.

A further advantage of the frame element is the possibility of absorbing any shocks that could impact the key, especially in the case of a frame element made of rubbery material.

As will be illustrated in some embodiments, preferably, the frame element has a rectangular shape, with two shorter sides and two longer sides.

In addition, the eyelet element is placed in the centre of one of the two shorter sides.

In view of the advantageous aspects pertaining to the device that is the object of the present invention just disclosed, the present invention also relates to a system for holding a key of a vehicle, such as a car, motorcycle, or the like, comprising a key, having a body with a peripheral edge.

In addition, the system comprises a frame element made according to one or more of the features described above and in which there is an eyelet element, which has a pin for attachment to the frame element.

According to a preferred embodiment, the key has a recess made along at least part of the peripheral edge, which identifies a housing seat of at least part of the frame element.

The recess in the key allows the frame element to be attached firmly to the key, preventing the key from being accidentally removed from the frame element.

These and other features and advantages of the present invention will become clearer from the following disclosure of some embodiment examples illustrated in the accompanying drawings in which:

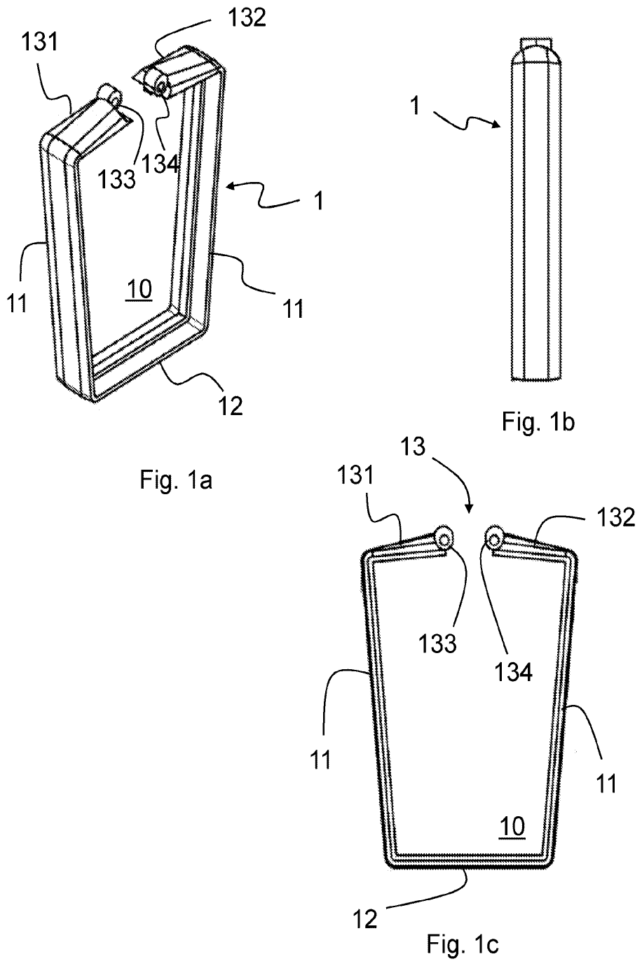

FIGS. 1a and 1c show two views of a possible embodiment of the device that is the object of the present invention, in an open condition;

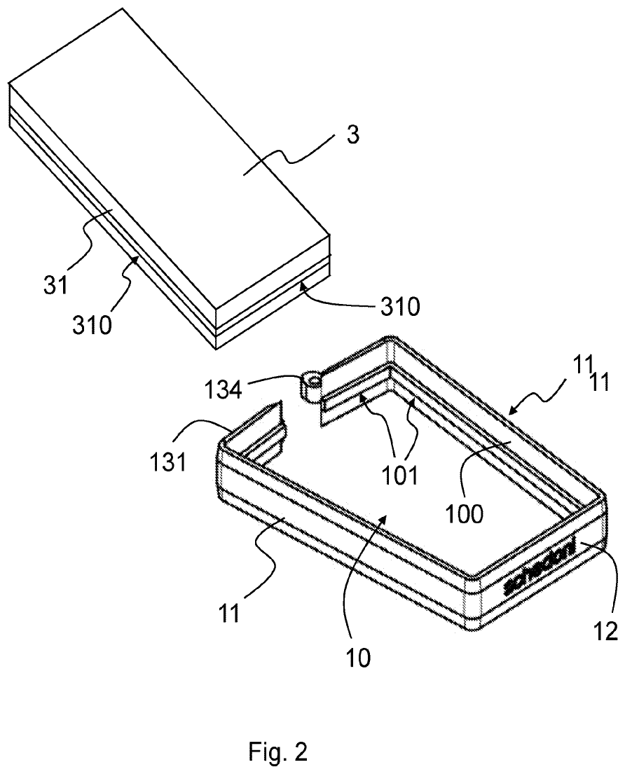

FIG. 2 shows a view of a possible embodiment of the device that is the object of the present invention that can be coupled to a key;

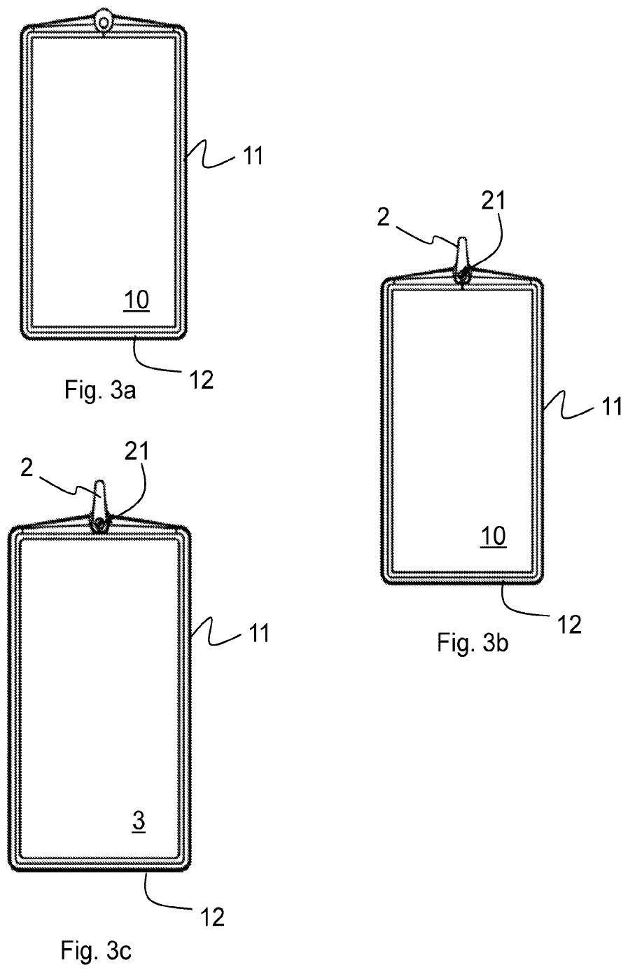

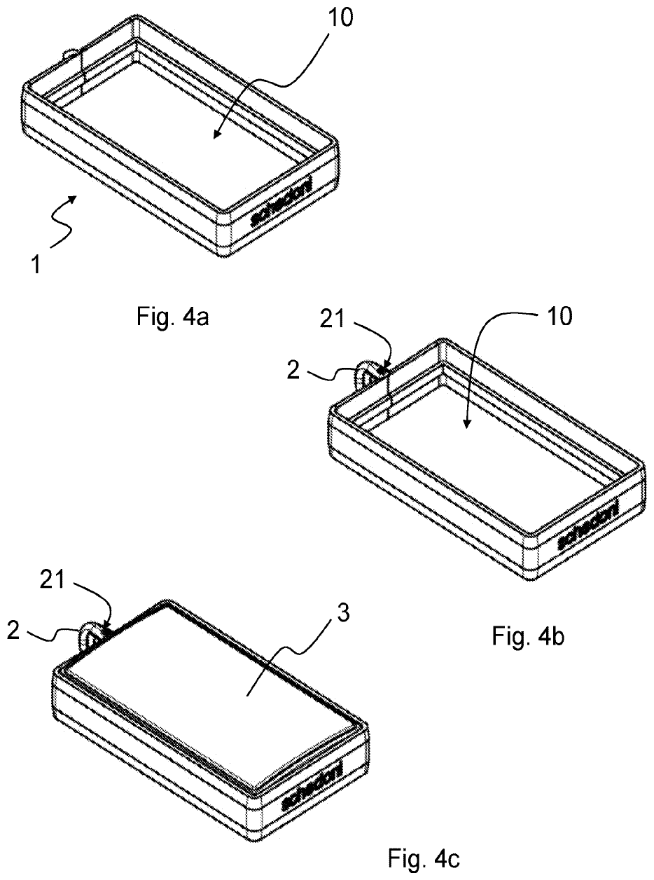

FIGS. 3a to 4c show some views of different embodiments of the device that is the object of the present invention.

It is specified that the figures attached to the present patent application show only some possible embodiments of the holding device for a key that is the object of the present invention, to better understand its described advantages and features.

Such embodiments are therefore to be understood as purely illustrative and not limiting to the inventive concept of the present invention, namely that of being able to easily couple any type of key to a keychain, in order to improve its portability and aesthetic appearance.

In general, the device that is the object of the present invention can be attached to a key having a body with a peripheral edge.

The holding device has a frame element, configured to surround and overlap the peripheral edge of said key, such that in an overlapped condition, the frame element is engaged with the body of the key.

The present invention provides that the frame element is made of any material known to the state of the art.

The frame element can also be realized as a continuous element, i.e. a continuous annular element, which completely surrounds the peripheral edge of the key, without interruption.

It follows that, according to this configuration, it is preferable that the frame element is made of a material that has a certain elastic deformation, that is, that it can be deformed to adapt to the shape and size of the key.

The implementation variant illustrated in the figures, on the other hand, shows a frame element made in a different way than the configuration just described.

According to what is illustrated in FIGS. 1a to 1c, the frame element is constituted by an elongated element 1 with ends that can be attached to each other so as to delimit an internal zone 10, which allows the housing of the body of the key, as will be described later.

The inner zone 10 has a rectangular shape, in that the elongated element 1 is folded so as to have a rectangular shape, with two lateral sections 11 of equal length, a lower section 12 and an upper section 13.

The upper section 13 is in particular divided into two segments 131 and 132, constituting the ends of the elongated element 1.

The segments 131 and 132 that can be attached to each other, so that the frame element switches from an open condition, as illustrated in FIG. 1a to 2, with the segments 131 and 132 separated from each other, to a closed condition, as illustrated in FIGS. 3a to 4c, with the segments 131 and 132 joined to each other.

Both the segment 131 and the segment 132 have a corresponding through hole 133, 134.

In particular, the segments 131 and 132 in their end part have an enlargement adapted to allow the creation of the through holes 133 and 134 in the thickness of the frame element.

As illustrated in the figures, in the transition from the open condition, FIG. 1c, to the closed condition, FIG. 3a, the holes 133 and 134 pass from a misaligned condition to an aligned condition, so as to identify a housing seat, configured for the insertion of an eyelet element.

In fact, the device that is the object of the present invention has an eyelet element 2, which has a pin 21 for attaching to the frame element.

The eyelet element 2 can be made according to any of the ways known to the state of the art, but preferably consists of a “C”-shaped arc having holes for housing the pin 21 at its ends.

FIG. 2 shows a schematic diagram of a possible key 3, consisting of a parallelopiped-shaped body having a peripheral edge 31.

The body of the key 3 will therefore have two longer and wider parallel faces and a side surface constituting the peripheral edge 31.

The key 3 can therefore be a key that uses the “keyless” system, or a key that integrates inside the body, preferably concealed, the metal part to be inserted inside the vehicle lock.

In the figures both the key 3 and the frame element 1 have a rectangular shape, but it is evident that any shape can be provided, even different shapes between the body of the key 3 and the frame element.

The transition from the open condition, FIG. 2, to the closed condition, FIG. 3c, allows the key 3 to be inserted and held.

In particular, starting from the condition of FIG. 2, the open condition of the frame element allows the insertion of the key 3 inside the zone 10 delimited by the frame element: in fact, in the open condition the internal zone 10 has dimensions greater than the dimensions of the body of the key 3, which can be housed inside the internal zone 10.

Once the key 3 is inserted in the inner zone 10, the segments 133 and 134 can be brought closer together, so as to limit the dimensions of the inner zone 10 and bring the inner surfaces of the frame element 1 into contact with the outer surfaces of the peripheral edge 31 of the body of the key 3.

Such a configuration is clearly illustrated in FIG. 4c, wherein the key 3 is completely inserted into the frame element and the frame element is completely overlapped on the peripheral edge 31 of the key body 3.

To maintain the closed condition of the frame element, the pin 21 of the eyelet element 2 is inserted into the through holes 133 and 134 which are, in a closed condition, aligned with each other.

The insertion of the pin 21 keeps the segments 131 and 132 attached to each other and, at the same time, the eyelet element 2 provides the hooking of the key 3 to a possible keychain.

In particular, the embodiments of 3a to 4c illustrate some perspective views of the device that is the object of the present invention, respectively with the frame element in closed condition, without key 3 and without eyelet element 2, FIGS. 3a and 4a, in closed condition without key 3 and with eyelet element 2, FIGS. 3b and 4b, in closed condition with key 3 and eyelet element 2, FIGS. 3c and 4c.

With particular reference to the variant illustrated in the figures, the frame element consists of a ribbon-shaped element configured to overlap with its surface the peripheral edge 31 of the body of the key 3.

With particular reference to FIG. 2, the ribbon-shaped element constituting the frame element 1 has, on its inner surface 100, a relief rib 101 arranged along the longitudinal axis of the ribbon-shaped element.

According to the variant illustrated in the figures, the relief rib 101 is arranged along the entire length of the inner surface 100 of the ribbon-shaped element, on the lateral sections 11, on the lower section 12 and on the upper section 13, but it is possible to provide that the relief rib 101 is present exclusively on some parts of the inner surface 100.

In fact, the function of this rib 101 is to cooperate with the peripheral edge 31 of the body of the key 3.

The relief rib 101 in fact extends in the direction of the peripheral edge 31, in such a way that, in the closed condition of the frame element, the relief rib 101 is inserted into a corresponding recess 310 placed on the peripheral edge 31 of the body of the key 3.

As for the relief rib 101, the recess 310 can also extend along the entire length of the peripheral edge 31 or only for part of the length, also based on the conformation of the relief rib 101, i.e. so that all parts of the relief rib 101 are housed inside corresponding recess parts 310.

While the invention is subject to various modifications and alternative constructions, some preferred embodiments have been shown in the drawings and described in detail.

It should be understood, however, that there is no intention to limit the invention to the specific illustrated embodiment but, on the contrary, the aim is to cover all the modifications, alternative constructions and equivalents falling within the scope of the invention as defined in the claims.

The use of “for example”, “etc.”, “or” refers to non-exclusive non-limiting alternatives, unless otherwise stated.

The use of “includes” means “includes but is not limited to”, unless otherwise stated.

1. Device for holding a key of a vehicle, such as a car, motorcycle, or the like, which key comprises a body having a peripheral edge, characterized in that
the said device comprises a frame element, which frame element is configured to surround and overlap the peripheral edge of said key,
in overlapped condition, the frame element being engaged to the body of said key,
there being an eyelet element, which eyelet element has a pin for attachment to the frame element.

2. Device according to claim 1, wherein said frame element is formed by an elastically deformable material.

3. Device according to claim 1, wherein the said frame element comprises an elongated element with its ends, that are attached or can be attached to each other so as to delimit an internal zone, which internal zone has the shape of the body of said key.

4. Device according to claim 1, wherein said frame element comprises an elongated element with ends that can be attached to each other, in such a way that said frame element passes from an open condition, with the ends separated from each other, to a closed condition, with the ends joined to each other.

5. Device according to claim 4, wherein each end has a corresponding through hole, which through holes are aligned with each other in the closed condition of the frame element, so as to identify a housing seat for the pin of the eyelet element.

6. Device according to claim 1, wherein said frame element comprises a ribbon-shaped element configured such that its surface overlaps the peripheral edge of the body of said key.

7. Device according to claim 6, wherein said ribbon-shaped element has a relief rib arranged along the longitudinal axis of the ribbon-shaped element, which rib extends in the direction of the peripheral edge of the body of the key.

8. Device according to claim 1, wherein said frame element has a rectangular shape, with two shorter sides (12, 13) and two longer sides, said eyelet element being placed in the centre of one of the two shorter sides.

9. System for holding a key of a vehicle, such as a car, motorcycle, or the like, comprising a key, which key has a body with a peripheral edge,
characterized in that said system comprises a frame element realized according to one or more of claim 1, there being an eyelet element, which eyelet element has a pin for attachment to the frame element.

10. System according to claim 9, wherein said key has a recess obtained along at least part of the peripheral edge which recess identifies a housing seat of at least part of said frame element.
